(19) United States
(12) Patent Application Publication
(10) Pub. No.: US 2003/0046148 A1
(43) Pub. Date: Mar. 6, 2003

(54) System and method of providing advertising on the internet

(76) Inventors: Steven Rizzi, Gambrills, MD (US); Christian Bridgers, Sausalito, CA (US)

Correspondence Address: BANNER & WITCOFF, 1001 G STREET N W, SUITE 1100, WASHINGTON, DC, 20001, US

(21) Appl. No.: 09/876,173

(22) Filed: Jun. 8, 2001

(51) Int. Cl. G06F 17/60

(52) U.S. Cl. 705/14

(57) ABSTRACT

A system and method for providing advertising on the Internet in which the advertiser can target particular users, and while maintaining a high degree of privacy. The system and method provides Internet advertising that is tailored to the user without creating a profile of the user, and can provide context sensitive promotion based on text contained in an Internet browser to maximize the amount of application intelligence on the client end. The system incorporates a server that maintains a database of promotional heuristics, behavior graphics, sponsorship authentication data, and usage statistics, and specialized applets. The system uses a servlet, which facilitates communication between specific applets and the server, and a web server, which provides the applets to the client browser. The system and method provide a simple and quick way for an advertiser to change the audience that is exposed to their advertisement.

### BACKGROUND OF THE INVENTION

The present invention relates to a system and method of providing advertising on the Internet. More particularly, the present invention is directed to a system and method for providing advertising that is tailored to the user without creating a profile of the user. The system and method provide context sensitive promotion based on text contained in an Internet browser. The system and method are designed to maximize the amount of application intelligence on the client end, such that privacy issues and concerns may be mitigated.

### DESCRIPTION OF THE PRIOR ART

Presently, the basic form of advertising on the Internet is through Internet banner advertising, which displays banners ads, usually at the top, on web pages. Banner ads are links that take a user to an advertiser's website when the user selects the banner ad. Banner ads are typically graphical images that drawn from the advertiser's server along with an associated link. When a user “clicks” on the banner ad he/she is taken to the web page of the advertiser.

Typically, the advertising banners are selected for presentation in one of two ways. The first criterion for selection of a banner advertisement is the web site itself. For example, for a web site is related to stock markets and financial data, presumably the people that visit that web site are interested in financial information. In order to reach that audience, brokerages, banks or manufacturers of accounting software might choose to have their banner advertisement displayed on the web site, and pay a fee to the web site for the display of their banners.

While the foregoing method of advertising on the Internet has become common it has drawbacks. One drawback is that it is based on the presumption that a visitor to that web site in interested in the product or services of the advertiser. The assumption is often incorrect and therefore the banner advertisement may be less effective. Additionally, for web sites having a broad focus, such as the Yahoo! Portal, visitors do not typically share a common interest or purpose, and therefore the ability of an advertiser to provide a targeted, effective advertisement is reduced.

Another drawback is that by choosing to advertise in such manner, advertisers have very little flexibility in altering the audience of visitors that see their banner advertisements. If a banner advertisement is not effective on a particular web site, one of the only options open to the advertiser is to stop advertising on that site and find a new web site to advertise through.

In order to improve the effectiveness of Internet advertising, a more sophisticated method of advertising on the Internet has been developed, in which the advertising is demographically targeted. In order to achieve such demographic targeting, the demographical information of the users must be obtained. One common way to gather this information is to have the users complete a questionnaire, provided via the Internet, as a prerequisite to providing access to the website. Another method of developing demographic information is to create a user profile for users based on their activities while on-line, (connected to the Internet). This method may maintain records for each user relating to what web sites have been visited, how frequently and for how long those websites are visited, how often the user makes a purchase on-line, and any demographic information the user supplies in the course of visiting websites.

Quite commonly, the foregoing method of gathering demographic information involves using “cookies.” A “Cookie” is a piece of information that a web site sends the visitor's computer. The cookie is virtually invisible to the visitor. However, the web site that placed the cookie can use the cookie to recognize the visitor whenever the visitor returns and to keep track of how often the visitor returns. This information is commonly referred to as traffic information. The use of cookies has become so prevalent that the file containing the cookies for a user can give a reasonable picture of the viewing or “surfing” habits and interests for a user. This is just the type of information that an advertiser can use to develop more effective Internet advertising.

Despite the benefits provided to advertisers and we site owners, a major obstacle to this form of advertising through the development of demographic information is the public's widespread desire for privacy. Such privacy concerns have become significant to the point where it has affected the manner in which people use the Internet, if at all. Privacy concerns are a major impediment to the growth of purchasing over the Internet. The general public has strong misgivings about providing personal information over the Internet, and about illegal activities such as identity theft. To counter such misgivings products and services have been introduced to try to maintain privacy. For example, software has been developed that prohibits the placement of cookies on a computer.

While such measures may help user maintain a higher degree of privacy, these measures inhibit an advertisers ability to provide targeted and therefore more effective advertising over the Internet.

### SUMMARY OF THE INVENTION

The deficiencies of the conventional methods are addressed by the present invention that is directed to a system and method for providing advertising on the Internet in which the advertiser can target particular users, and yet still maintains a high degree of privacy.

The system and method according to the present invention provides Internet advertising that is tailored to the user without creating a profile of the user. The system and method provide context sensitive promotion based on text contained in an Internet browser, and are thereby maximize the amount of application intelligence on the client end, in such manner that privacy issues and concerns may be mitigated.

The system incorporates a server that maintains a database of promotional heuristics, behavior graphics, sponsorship authentication data, and usage statistics, and specialized applets. The system uses a servlet, which facilitates communication between specific applets and the server, and a web server, which provides the applets to the client browser.

An advantage of the system and method of the present invention is that they to provide way for advertisers to present tailored advertisements to web site visitors without compromising the privacy of the visitors.

Another advantage of the system and method according to the present invention is that they provide a vehicle for advertisers to specifically target their advertising.

Yet another advantage of the system and method according to the present invention is that they do not gather user information.

Still another advantage of the system and method according to the present invention is that they utilize text content displayed on an Internet browser to select an advertisement to be displayed.

Another advantage of the system and method according to the present invention is that they provide a simple and quick way for an advertiser to change the audience that is exposed to their advertisement.

### BRIEF DESCRIPTION OF THE DRAWINGS

These and other attributes of the present invention will be described with respect to the following drawings in which:

FIG. 1 is a block diagram of the system according to the present invention; and

FIG. 2 is a flow chart of the operation of the method according to the present invention.

### DETAILED DESCRIPTION OF THE INVENTION

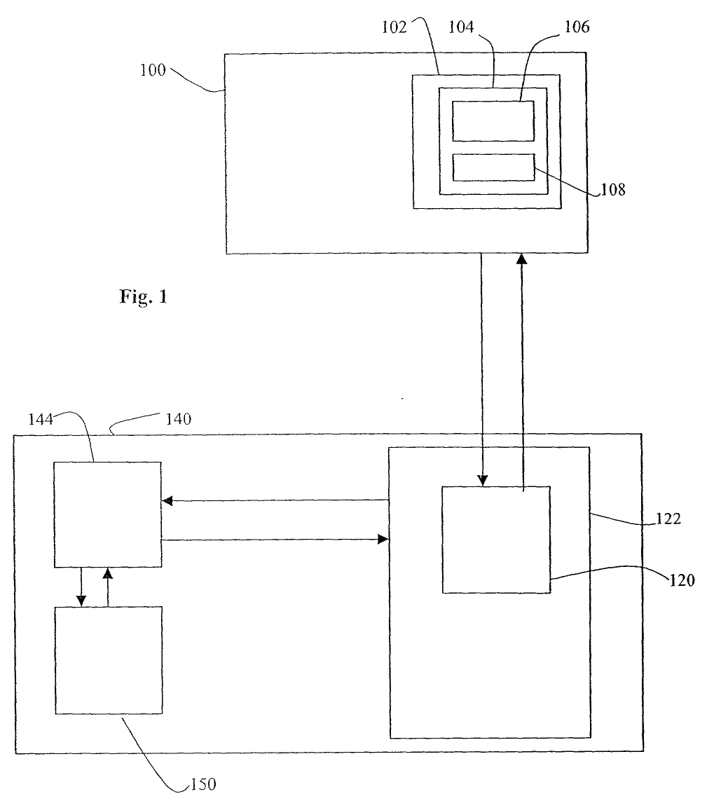

Referring to FIG. 1, a block diagram of the system 200 for providing advertising on the Internet according to the present invention is shown. The system 200 includes a computer user computer 100, a web server 120, and an advertising server 140.

Computer 100 contains, among other components, a central processor, a display device 102, and some form of interface coupling the computer 100 to the Internet. The existence of any of various well-known protocols, such as TCP/IP, Frame Relay, Ethernet, FTP, HTTP and the like, is presumed, and a user of the computer 100 can retrieve web pages from the web-based server 120. The computer 100 has a graphical user interface 104. Any of various conventional web browsers, such as Microsoft's Internet Explorer™, or Netscape's Navigator™, can be used to display and manipulate data on web pages on the graphical user interface 104.

The graphical user interface 104 has a main window 106 for displaying web pages. A banner ad location 108 is also provided in the graphical user interface 104, through which targeted advertisements may be displayed.

The advertising server 140 includes a database 144, which stores promotional heuristics and behavior graphics, sponsorship authentication data, and usage statistics, the web server 120, and a servlet 150 that facilitates communication between the applets 122, from the web server 120, and the advertising server 140. A servlet is an applet that runs on a server. A servlet refers to a Java applet that runs within a Web server environment, and is analogous to a Java applet that runs within a Web browser environment.

The web server 120 serves the applets 122 to the browser loaded in the graphical user interface 104 on the computer 100. In a preferred embodiment the applets are loaded into a Java™ enabled web browser, such as Microsoft's Internet Explorer™, or Netscape's Navigator™.

The primary function of the applets 122 is to read textual content in the browser, displayed in the window 106. A banner advertisement is selected to be displayed in ad location 108 based on the occurrence of selected key words and phrases in the discovered textual content displayed in the browser. The database 144 uses the promotional heuristics to determine which banner ad should be displayed in the ad location 108. These promotional heuristics may be self-educating, so that when a user clicks on a displayed banner ad in the ad location 108, the database is updated with the knowledge that the selected banner ad was a good match for the key words and phrases in the textual content.

The promotional heuristics are self-learning; they get better with experience. The promotional heuristics do not always reach the very best result but usually produce a good result.

For example, if the key words found in the textual content include “gourmet food” and “wine,” then a banner ad for a website that sells wines to wine connoisseurs might be selected. If the user responds by clicking on the banner ad in the ad location 108, then the fact the banner ad received a positive response when those key words are detected in stored in the promotional heuristics.

The behavior graphics in the database 144 may contain information relating to the likelihood that a person interested in one topic will be interested in a second topic or will respond to an advertisement pertaining to a second subject. For example, the database might contain information indicating that a person interested in sports is likely to be interested in sports memorabilia.

The sponsorship authentication data in the database 144 may include information to indicate the actual sponsors for each website, and may further include information listing website sponsors who are subscribers to the advertising system of the present invention. In this manner, the system can track the success rate of the banner advertisements for subscribing sponsors.

The database 144 also contains the usage records. These usage records may include data relating to how often each of the supplied banner ads is used or “clicked on” by users.

An advantage of the system and method of the present invention is that an advertiser can quickly and easily change the promotional heuristics for their banner advertisement. Such a change may be instituted in response to the usage data and behavior graphics. For example, if the usage data shows that users are not clicking on the advertiser's banner ad then the key words or phrases appearing in the textual content may be changed quickly and easily, to try to display the banner ad to a different and hopefully better targeted group of users. This is simpler than producing a new banner ad, when it may not be the banner ad itself, but rather the audience that is being exposed to the banner ad.

One of the functions of the web server 120 is to send the applets 122 to the browser displayed in window 106. An applet is a program that is designed to be executed from within another application, here a web browser. Web browsers, which are often equipped with Java™ virtual machines, can interpret applets from web servers, such as web server 120. Because the applets 122 are small in file size, cross-platform compatible, and highly secure, i.e. they cannot be used to access hard drives on a user's computer 100. Applets are well suited for small Internet applications that are used in a web browser. Applets often perform various operations in Hypertext Markup Language (HTML) web browsers. Such web browsers are often Java™ enabled, meaning the web browsers can execute applets written in the Java™ programming language. Java™ applets are commonly contained in data downloaded by a user over the Internet via a web browser. Applets that execute in a web browser can make the web browser perform many operations, such as locating and playing pieces of audio information, displaying a short message in the status line, displaying animation, or displaying a different web page. A preferred embodiment uses an HTML web browser with a Hypertext Transfer Protocol (HTTP).

As stated previously the primary purpose of the applets 122 is to read the textual content in the web browser. This reading may be performed in real time. As a result, the applets do not cause the textual content to be cached, either in the user's computer 100, the web server 120 or the advertising server 140. Consequently, users are provided a higher degree of privacy. No data is collected that might be used to profile the users.

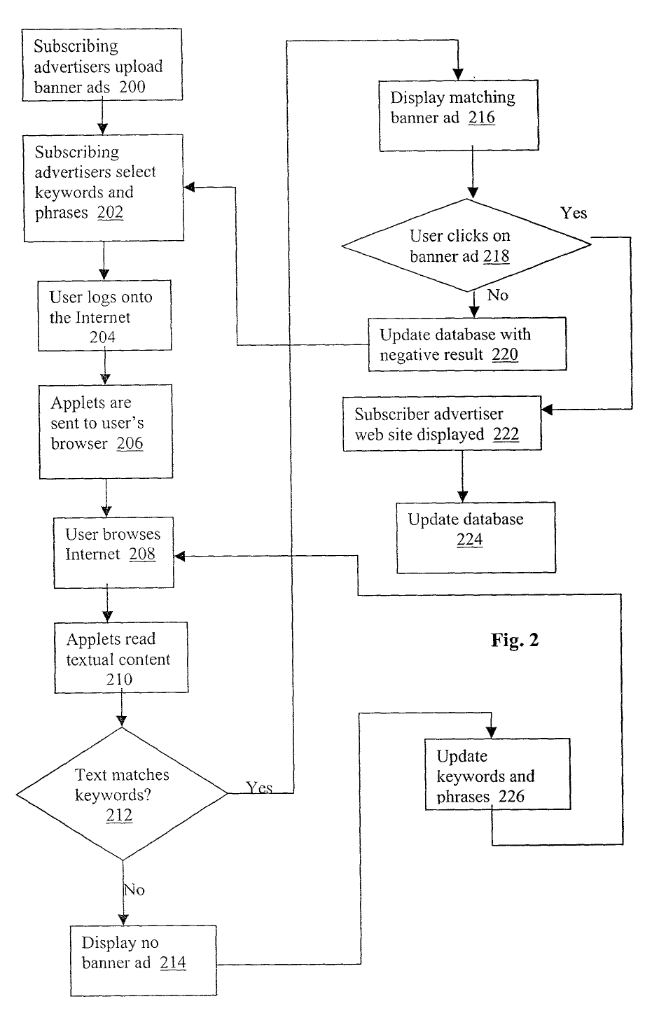

The method of the present invention will now be described with reference to the flow chart shown in FIG. 2. In step 200 subscribing advertisers upload banner ads to the advertising server 140. In step 202 the subscribing advertisers select the keywords and phrases that will be compared to the textual content displayed in the browser to indicate a match.

Next, a user logs onto the Internet via a web browser on computer 100, in step 204. In response to the user's log on, the web server 120 sends the applets 122 to the web browser in step 208. The applets 122 read the textual content displayed on the web browser in real-time, in step 210.

A comparison of the textual content and the keywords or phrases is continual made in step 212. If the result of the comparison in step 212 is positive, a matching banner ad is displayed in step 216. The comparison and display of the banner ad are preferably executed in real-time. As a consequence the user may receive banner ads that are relevant to their immediate subject matter, thereby increasing the likelihood that the user will click on the banner ad.

If the keywords or phrases do not match in step 22, no banner ad will be displayed in step 214. Subsequently, the keywords and phrases for one or more subscribing advertisers may be updated in step 226, if the results of step 212 are predominantly negative, thereby resulting in minimal traffic to the subscribing advertisers web site. After step 226, the method returns to step 208, where the user continues to browse the Internet.

Returning to the comparison step 212, if the textual content and keywords or phrases match, and the corresponding banner ad is displayed, a determination is made, in step 218, whether the user clicks on the banner ad. If the result of the determination in step 218 is positive then the subscriber advertiser's web site is displayed on the user's browser in step 222. In addition, the database 144 in the advertising server 140 is updated to note that the keywords or phrases produced a successful target by bringing a user to the subscriber' web site.

If the user does not click on the banner ad in step 218, then the database 144 is updated with negative results in step 220. After step 220, the method may return to step 202 so that the subscribing advertiser may update the keywords and phrases in order to improve their positive results. Alternatively, step 220 could proceed to step 208 in a manner similar to step 226. Subscribing advertisers may change the behaviors of their ads in real-time via a web-based interface in order to rapidly respond to promotional and/or public relations opportunities.

The circumstances of the updating of the keywords and phrases are different in step 226 and the return to step 202 after step 220. Step 226 occurs because no matches are occurring between the textual content and the keywords and phrases. On the other hand step 220 is achieve only after there has been a match between the keywords and phrases and the textual content displayed in the web browser, but the user has chosen not to select the banner ad.

In a preferred embodiment of the system and method of the invention, a subscribing advertiser may have more than one banner ad. Each banner ad may have different keywords and phrases so that the different banner ads are displayed when different textual content is displayed on a web browser.

A preferred embodiment performs the comparisons and determinations, as well as displayed any corresponding banner ads in real time. As a consequence, data, which might be used to profile the user, is not collected. No user profiling data is forwarded to the advertising server 140 for collection, and any temporary information that might apply to privacy concerns never leaves the user's computer 100, and such temporary information is destroyed when the browser is closed.

While the foregoing refers to banner ads, other forms of ads or links may be utilized, such as pop-up ads. Furthermore, while the foregoing description addresses comparisons with textual content, the system and method could compare real-time visual or audio information that is received through a user's web browser.

Having described several embodiments of the system and method for providing Internet advertising in accordance with the present invention, it is believed that other modifications, variations and changes will be suggested to those skilled in the art in view of the description set forth above. For example, while the foregoing description of the present invention is described with regard to a single user in order to facilitate the explanation of the invention, it is expected that a great many browsers on numerous users' computers will be using the present invention simultaneously. It is therefore to be understood that all such variations, modifications and changes are believed to fall within the scope of the invention as defined in the appended claims.

I/We claim:

1. A system for providing Internet advertising, comprising:
an advertising server comprising a web server having at least one applet; and
at least one computer comprising a web browser and a display unit;
said web browser receiving said at least one applet from said web server, said at least one applet reading textual content displayed on said web browser;
said advertising server further comprising a database, and a servlet for receiving said textual content read from said at least one browser by said at least one applet, said advertising server comparing said textual content to keyword data stored in said database to determine whether to display an ad on said web browser.

2. A system for providing Internet advertising, as recited in claim 1, wherein said database comprises promotional heuristics, behavior graphics, sponsorship authentication data, and usage records.

3. A system for providing Internet advertising, as recited in claim 1, wherein said keyword data is provided for a plurality of subscriber advertisers, said keyword data corresponding to multiple ads.

4. A system for providing Internet advertising, as recited in claim 1, wherein said advertising server compares said textual content to said keyword data in real-time.

5. A system for providing Internet advertising, as recited in claim 1, wherein said browser is a Java™ enabled web browser.

6. A system for providing Internet advertising, as recited in claim 5, wherein said at least one applet is a Java™ applet.

7. A system for providing Internet advertising, as recited in claim 1, wherein said advertising server further comprises a servlet that facilitates communication between said at least one applet and said advertising server.

8. A system for providing Internet advertising, as recited in claim 1, wherein said ad is a banner ad.

9. A system for providing Internet advertising, as recited in claim 1, wherein said advertising server causes an ad specifying said keyword data to be displayed in said browser when said keyword data matches words in said textual content displayed in said browser.

10. A system for providing Internet advertising, as recited in claim 7, wherein said advertising server causes an ad specifying said keyword data to be displayed in said browser when said keyword data matches words in said textual content displayed in said browser.

11. A system for providing Internet advertising, as recited in claim 10, wherein servlet receives data from said at least one applet and said advertising server causes said browser to display said ad specifying said keyword data.

12. A system for providing Internet advertising, as recited in claim 11, wherein said browser displays a web site designated by said ad when said ad is selected.

13. A system for providing Internet advertising, as recited in claim 2, wherein said promotional heuristics determine which ad should be displayed.

14. A system for providing Internet advertising, as recited in claim 13, wherein said promotional heuristics are self-educating, so that when a user selects said displayed ad, said database is updated to indicate that said selected ad was a good match for said keyword data and said textual content.

15. A system for providing Internet advertising, as recited in claim 2, wherein said behavior graphics in said database contain information relating to the likelihood that a person interested in one topic will be interested in a second topic or will respond to an advertisement pertaining to said second topic.

16. A system for providing Internet advertising, as recited in claim 2, wherein said sponsorship authentication data in said database comprises information indicating sponsors who are subscribers to system.

17. A system for providing Internet advertising, as recited in claim 1, wherein said database tracks a success rate of said displayed ad.

18. A system for providing Internet advertising, as recited in claim 2, wherein said usage records comprise data relating to how often each ad is accessed by users.

19. A system for providing Internet advertising, as recited in claim 18, wherein said keyword data for a corresponding ad can be changed in response to said usage data and behavior graphics.

20. A system for providing Internet advertising, as recited in claim 1, wherein said browser is an HTML web browser with a HTTP.

21. A method of providing Internet advertising, comprising the steps of:
uploading ads to an advertising server;
selecting keyword data for each ad;
sending an at least one applet to a browser on a user's computer, in response to the user's logging on;
said applets reading textual content displayed on said web browser;
comparing said textual content read by said at least one applet with said keyword data; and
displaying an ad having keyword data matching said textual content when said comparing step produces a match.

22. A method of providing Internet advertising, as recited in claim 21, wherein said steps of comparing and displaying said ad are executed in real-time.

23. A method of providing Internet advertising, as recited in claim 21, comprising the further step of displaying no ad when said textual content does not match said keyword data.

24. A method of providing Internet advertising, as recited in claim 23, comprising the further step of updating said keyword data when said textual content does not match said keyword data.

25. A method of providing Internet advertising, as recited in claim 21, comprising the further step of determining whether a uses selects said ad in response to said displaying step.

26. A method of providing Internet advertising, as recited in claim 25, comprising the further step of displaying on the user's browser a web site linked to said ad.

27. A method of providing Internet advertising, as recited in claim 25, comprising the further step of updating a database in said advertising server to note that said keyword data produced a successful target by bringing the user to said web site.

28. A method of providing Internet advertising, as recited in claim 25, comprising the further step of updating a database on said advertising server when the user does not click on said ad.

29. A method of providing Internet advertising, as recited in claim 21, wherein said ads are banner ads.

30. A method of providing real-time advertising over the Internet, comprising the steps of:
maintaining a database of a plurality of ads;
maintaining keyword data for each of ads;
sending an applet to a browser on a user's computer;
reading textual content displayed on said browser using said applet;
comparing said textual content read by said applet with said keyword data for each of said ads; and
displaying an ad having keyword data matching said textual content when said comparing step produces a match.
